(19) United States
(12) Patent Application Publication
(10) Pub. No.: US 2012/0222934 A1
(43) Pub. Date: Sep. 6, 2012

(54) ADJUSTABLE VARIABLE ENGAGEMENT CLUTCH

(76) Inventor: David Maslar, Gambrills, MD (US)

(21) Appl. No.: 12/906,062

(22) Filed: Oct. 15, 2010

Related U.S. Application Data
(60) Provisional application No. 61/251,850, filed on Oct. 15, 2009.

(51) Int. Cl. F16D 13/75

(52) U.S. Cl. 192/76

(57) ABSTRACT

The invention is directed to an adjustable clutch or torque control device. The adjustable clutch or torque control device includes a flywheel with an at least one shoe or friction transfer device and an at least one adjustment mechanism and an at least one spring member. A portion of the at least one adjustment mechanism exists within the flywheel such that it is adjusted without the removal of the clutch bell or the disassembly of the clutch and adjusts the at least one spring member so that it changes a point of engagement of the at least one shoe or friction transfer device.

### CROSS-REFERENCE TO RELATED APPLICATIONS

This application claims the priority of U.S. provisional patent application 61/251,850, filed Oct. 15, 2009, which is incorporated herein by reference.

### BACKGROUND OF THE INVENTION

With the use of any type of internal combustion engine as a method of powering a vehicle or mechanism, there is always the necessity of transferring the power from the engine to the mechanism being driven. As part of this power transfer it is often necessary to entirely disengage the engine from the mechanism. To facilitate a complete disengagement of the power transfer, it is necessary to provide a clutch mechanism to the device to temper the delivery of power from the now rotating motor and the mechanism itself when power engagement is desired. These clutch devices vary widely in scope and design. The disclosed invention relates to the use of centrifugally activated clutches as commonly used in Radio Controlled (R/C) Cars and Trucks, but could also be used in any device where a centrifugal clutch is employed and where a quick and easy adjustment of the characteristics of the engagement of the clutch are desirable.

The field of fuel powered R/C vehicles has for years relied upon a simple centrifugal clutch system to control the engagement of the engine to the vehicle. This allows the motor to be started and tuned without controlling or restricting the movement of the vehicle by some other means. Typically, these devices have a flywheel, which possess a number of friction shoes, which may be attached to or carried by the flywheel in any number of configurations. These shoes are held close to the center of the flywheel by a spring member or members and, at low or no rotational speed, are prevented from touching a clutch bell, which surrounds the shoes themselves and positively engages to the vehicle itself through some type of gearing or transmission.

As the rotational speed of the motor increases, at some point, the centripetal force produced by the geometric design of the clutch shoes and flywheel, will cause some portion of the shoes to overcome the force of the spring and rotate or slide outward to make contact with the clutch bell. This contact will begin to transfer the rotational force from the engine to the clutch bell and subsequently the vehicle itself. This methodology is the basis for any centrifugally activated clutch system.

Typical of the more common styles of clutch design is the presence of shoe anchor pins, commonly pressed into the flywheel radially off-center, which act as pivot points for the clutch shoes. The clutch shoes which have a hole drilled through one end, slide over the anchor pins and have a torsion springs which fits into a slot machined in the center of the shoe. One end of the spring is fixed on the shoe and the other is snapped around the center-line main crank shaft for tension. The clutch shoe is thus held in place until the rotational force is reached causing the free end of the shoe to rotate, around the anchor pin, until it contacts the clutch bell.

With such a system, the nature of the power delivery will, to a great degree, be related to the geometric design of the shoes and flywheel as well as the friction surfaces of the shoe and the clutch bell. Some designs will allow for an abrupt delivery of power, while others will deliver power in a more gradual manner. Regardless of the inherent design of the clutch mechanism itself, the springs used to restrict and control the motion of the shoes will always determine the nature and speed of the engagement. Typically, a stiffer spring or one that possesses a higher pre-load or spring rate will be able to withstand greater rotational speed before yielding to the increasing centripetal forces and allowing the shoes to move outward and contact the clutch bell. Likewise, a softer spring will yield more quickly and allow engagement at a lower rpm.

It is widely known that the ability to adjust or tune the characteristics of the engagement is desirable. Though the clutch devices available on the market provide many ways to control the engagement of the clutch but typically lack one or more desirable characteristics and are many times cumbersome and time consuming to use. Many of the devices and methods currently employed to tune the engagement require the removal of the clutch bell and some times the disassembly of the clutch itself to make the necessary changes. This typically requires that the motor itself be removed from the vehicle, with the disconnection of the fuel lines and throttle control devices being necessary as well. All of the time overhead required to make changes to the engagement can add up to 10 minutes or more, and if the changes made to the system are incorrect there is no way of knowing until the motor is re-installed and run on the vehicle. This time consuming process no doubt leads to the under use of such devices to account for the differing track conditions which are typically present during a day of operation.

The desirability of such adjustments is further evidenced by the wide range of tuning methods, including adjustable clutches currently available in the marketplace. Among the methods used for tuning the engagement are the use of differing shoes materials, heavier or lighter springs, and even screw adjustable spring tension devices that allow for a gradual change of the engagement characteristics. An example of one such device is the WERKS Power Clutch (http://werksracing.com/faq.do?id=4), which utilizes a spring member that extends in line with the center-line main crank shaft and is sandwiched between two counter rotating nuts. The nuts adjust the properties of the spring. Though adjustable, the entire clutch assembly must be removed or otherwise significantly disassembled to make any adjustments, a major drawback to these and similar systems.

Therefore, a need exists for an adjustable clutch with easier access to the adjustment mechanisms for quicker and more convenient adjustment. Among the various devices and methods for tuning the engagement of the clutch, a further desirable characteristic is a device which allows for a slight or gradual change to the spring tension thereby allowing a fine adjustment of the engagement characteristics. Another is the ability to independently adjust the engagement point of the various shoes, thereby giving better fine adjustment characteristics as each of the shoes in the device can be adjusted for variance in manufacturing variances. This gives the user some control of not only the rpm point where engagement begins, but also the degree to which torque is transferred during the period between initial engagement and full engagement (the point where the potential to deliver torque is greater the engine can produce). An additional factor in the R/C field is the necessity of the device being cost effective to manufacture as the participation in R/C activities is primarily a hobby.

### SUMMARY OF THE INVENTION

An object of the invention is to provide an easily adjustable clutch or torque control device with an adjustment device that enters along the axial or radial plane of the flywheel of the adjustable clutch or torque device.

The invention includes an adjustable clutch or torque control device having a flywheel, an at least one shoe or friction transfer device, an at least one adjustment mechanism and at least one spring member. Where some portion of the at least one adjustment mechanism exists within the flywheel such that it can be adjusted without the removal of the clutch bell or the disassembly of the clutch and adjust the spring member so that it changes a point of engagement of the at least one shoe or friction transfer device.

The invention also includes an adjustable clutch or torque control device having a flywheel, an at least one shoe or friction transfer device, and at least one spring member, where a portion of the spring or an extension of the spring penetrates the plane of the flywheel where it intersects or can be acted upon by a device which can effect the tension of the at least one spring member.

The invention further includes an adjustable clutch or torque control device comprising with a flywheel, an at least one shoe or friction transfer device; and

at least one spring member, where a portion of a spring tension control mechanism penetrates out from the plane of the flywheel and intersects with the at least one spring member or any extension of the at least one spring member and can be acted upon to effect the tension of the spring.

The at least one shoe or friction transfer device can include more than one shoe or friction transfer device. The at least one spring member can further comprise more than one spring member. The at least one flywheel can engage a crankshaft in a remotely controlled vehicle. The at least one flywheel can engage a crankshaft in a remotely controlled vehicle and transfers power from an internal combustion engine. The at least one spring member can be completely recessed within the flywheel. The at least one shoe can be guided by a pin pivot point. The at least one shoe can also be guided by a set of grooves in the flywheel. The flywheel can have an upper face and the at least one spring member or a carrier for the at least one spring member can penetrate the upper face of the flywheel.

The adjustable clutch or torque control device can further include an adjustment mechanism slot or hole, wherein the adjustment mechanism penetrates the flywheel through the adjustment mechanism slot or hole and radially extends into the flywheel and engages the at least one spring member to adjust the spring characteristics of the at least one spring member and thereby the engagement point of the shoe member.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows an isometric view of a fully assembled clutch assembly of the instant invention.

FIG. 2 shows a still further isometric view from a higher angle of a fully assembled clutch assembly and the movement of the shoe components.

FIG. 3 shows four views, including a top down, an isometric, and two side views of a the flywheel assembly of the instant invention including the penetrating cuts for the adjustment mechanisms and the relief cuts for the spring mechanisms.

FIG. 4 shows four views, including a top down, an isometric and two side views, of a clutch shoe from the instant invention.

FIG. 5 shows four views, including a top down, an isometric and two side views, of a torsion spring from the instant invention.

### DETAILED DESCRIPTION OF THE INVENTION

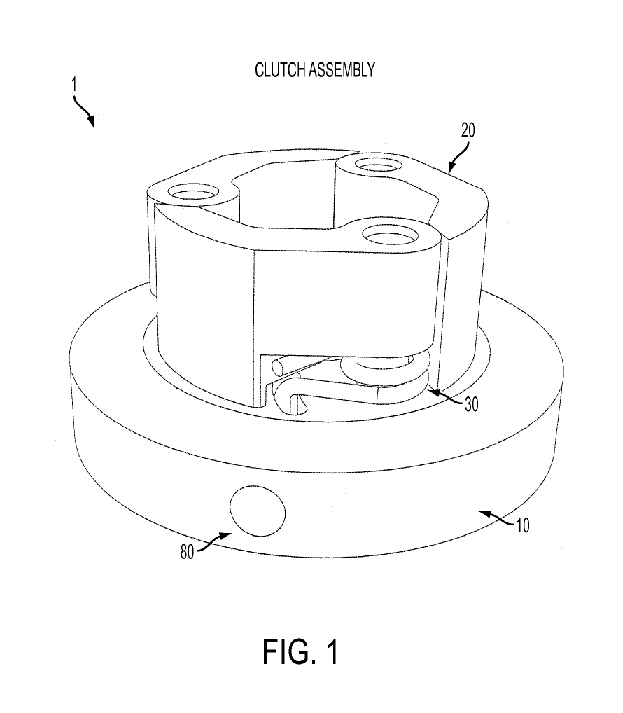

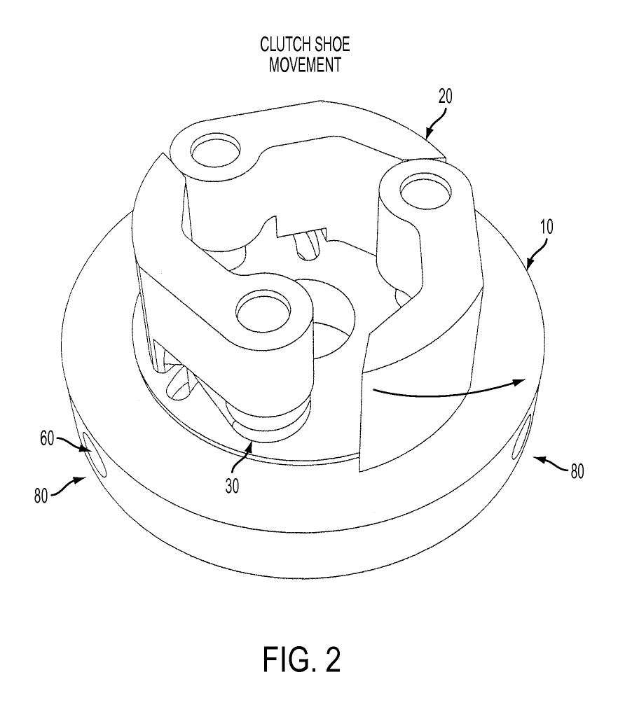

FIG. 1 shows an isometric view of a fully assembled clutch assembly of the instant invention and FIG. 2 shows a still further isometric view from a higher angle of a fully assembled clutch assembly and the movement of the shoe components. As seen in the figures, the clutch assembly or torque transfer device 1 has a flywheel 10 with shoes 20 mounted thereon and spring members 30 biasing the shoes 20 against movement. As can be seen in both FIGS. 1 and 2, the flywheel 10 also provides for adjustment mechanism access holes 80 around its perimeter, the adjustment mechanism access holes 80 being in the radial plane of the flywheel 10, that is cut in radially along the flywheel 10. The spring members 30 are biased to prevent the centrifugal forces on the shoes 30, which when spun exhibit the movement shown in FIG. 2.

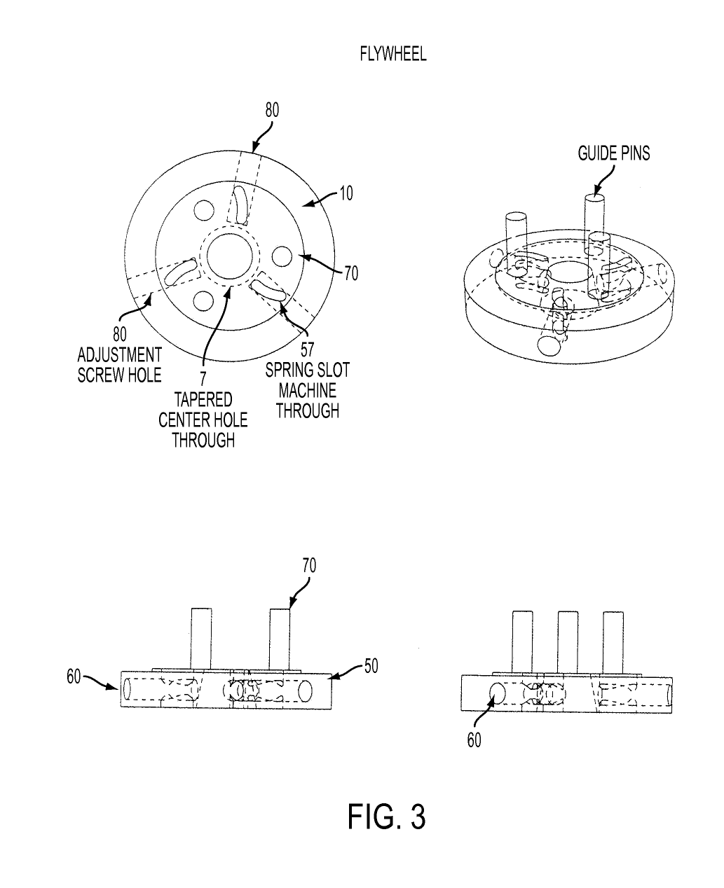

FIG. 3 shows four views, including a top down, an isometric, and two side views of a the flywheel assembly of the instant invention including the penetrating cuts for the adjustment mechanisms and the relief cuts for the spring mechanisms. The invention, as noted, comprises at least in part a flywheel 10, shoes 20 and associated spring members 30 which allows for the independent adjustment of the spring tension of the spring members 30 controlling the movement of each shoes 20. This adjustment can be made quickly and easily without removing or modifying any portion of the motor or vehicle.

The improved access to the adjustment of the tension of the spring members 30 is accomplished by changing the anchor point of the spring member(s) 20 from the center line orientation of the crankshaft 5 typical in such devices to a point that lies within the flywheel 10. The flywheel has several holes machined into it. A center hole 7 accommodates the crankshaft 5. The flywheel 10 can be machined to allow the penetration of the end of the spring members 30. To accommodate the penetration of the spring members 30, a slot or recessed portion or hole or other recessed area 57 is machined into the flywheel 10.

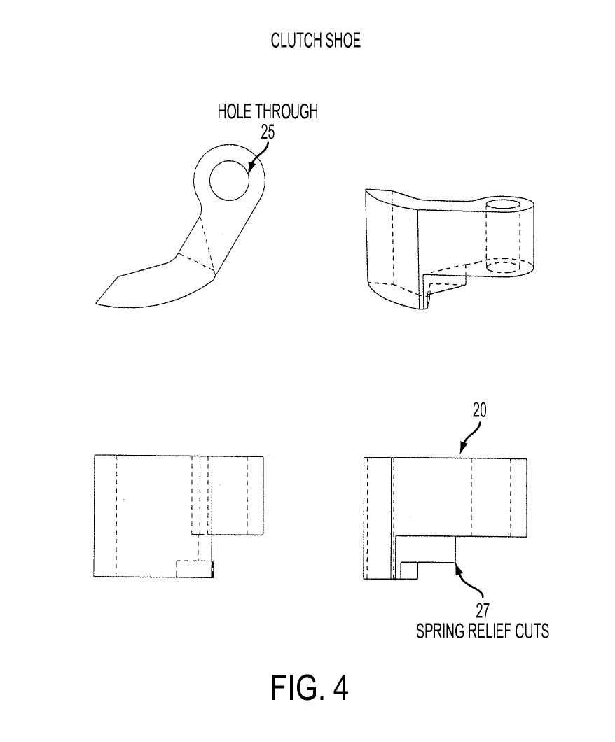

The end position of the spring member or spring members 30 can then be adjusted by the use of an adjustment mechanism 60, for instance a threaded screw, which penetrates the flywheel 10 and intersects the spring members 30 within the flywheel 10. The shoe 30 itself can also be machined, as seen in FIG. 4, to accommodate the new orientation and movement of the spring member(s) 30. The new orientation moves the spring member 30 away from the center of axis point of the shoes 20 on a guide pin 70 to a newly located center at the bottom of the shoe 20 where it mates with the upper face 55 of the flywheel 10.

The flywheel 10 will posses one or more guide pins 70, as shown, which are pressed into, or otherwise secured to the flywheel 10 and project from the upper face 55 of the flywheel 10 outward. In addition the flywheel 10 can posses a spring slot 57 or other recessed area which will allow for a portion of the spring member 35, here a torsion spring, to penetrate the upper plane or face 50 of the flywheel 10. This allows the intersection of the spring member 30 with an adjustment mechanism slot or adjustment mechanism access hole or holes 80. The adjustment mechanism access hole 80 allows an adjustment mechanism 60 such as for instance, but certainly not limited to, a screw or other movable device, to contact the spring member 30 and adjust its properties.

The adjustment mechanism or device 60 can be manipulated by the user to change the spring tension for each of the spring member(s) 30 that couples to each of the shoes 20 present on the clutch 1. The clutch 1 may have only one shoe 20 or it may have many, depending on the design and application. Similarly, the shoes 20 may have one or several spring members 30 associated with them. The adjustment device 60 can be manipulated to change the characteristics of the spring member 30 and thereby the engagement of the shoe(s) 20 in the clutch 1.

In a further exemplary embodiment, the adjustment mechanism can further comprise a block or carrier to intersect the control device in the flywheel and penetrate outward through the upper face or plane 55 of the flywheel 10 where it could intersect with the end of the spring member 30. In this embodiment, the carrier would move during adjustment and would apply force to the spring portion 35.

FIG. 4 shows four views, including a top down, an isometric and two side views, of a clutch shoe from the instant invention. The clutch shoe 20 possesses a guide pin hole 25 through which slides the guide pins 70, providing a rotation point for the clutch shoe 20. It may also posses some additional features for the purposes of seating the spring member 30 securely or providing relief for the movement of the spring member(s) 30. One such feature would be relief cuts 27 in the shoe or shoes 20 to provide for movement of the shoe 20 over the spring member 30.

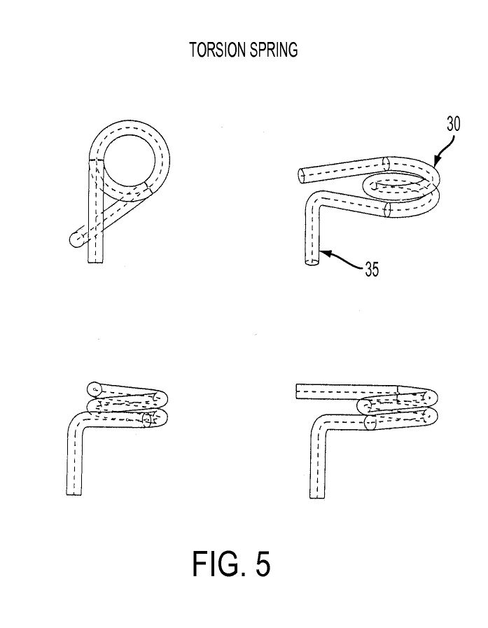

FIG. 5 shows four views, including a top down, an isometric and two side views, of a torsion spring from the instant invention. The spring member 30, here shown as a torsion spring, will have a geometry which allows it to hook the shoe 20 and penetrate the upper plane 50 of the flywheel 10, to intersect with the adjustment device 60. The specific materials and design of the spring members 30 and the adjustment device 60 can vary widely according to the application. In an exemplary embodiment shown, the spring member 30 is a helical spring with a portion 35 extending down at an end and into the spring slot 57 and engaging the adjustment device 60.

The embodiments, exemplary embodiments, and examples discussed herein are non-limiting examples of the invention and its components. The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An adjustable clutch or torque control device comprising:
a flywheel at least one shoe or friction transfer device;
an at least one adjustment mechanism; and
at least one spring member, wherein a portion of the at least one adjustment mechanism exists within the flywheel such that it is adjusted without the removal of the clutch bell or the disassembly of the clutch and adjusts the at least one spring member so that it changes a point of engagement of the at least one shoe or friction transfer device.

2. The adjustable clutch or torque control device of claim 1, wherein the at least one shoe or friction transfer device comprises more than one shoe or friction transfer device.

3. The adjustable clutch or torque control device of claim 2, wherein the more than one shoe or friction transfer device comprises three shoes or friction transfer devices.

4. The adjustable clutch or torque control device of claim 1, wherein the at least one spring member further comprises more than one spring member.

5. The adjustable clutch or torque control device of claim 4, wherein the more than one spring member comprises three spring members.

6. The adjustable clutch or torque control device of claim 1, wherein the at least one flywheel engages a crankshaft in a remotely controlled vehicle.

7. The adjustable clutch or torque control device of claim 1, wherein the at least one flywheel engages a crankshaft in a remotely controlled vehicle and transfers power from an internal combustion engine.

8. The adjustable clutch or torque control device of claim 1, wherein the at least one spring member is completely recessed within the flywheel.

9. The adjustable clutch or torque control device of claim 1, wherein the at least one shoe is guided by a pin pivot point.

10. The adjustable clutch or torque control device of claim 1, wherein the at least one shoe is guided by a set of grooves in the flywheel.

11. The adjustable clutch or torque control device of claim 1, wherein the flywheel has an upper face and the at least one spring member or a carrier for the at least one spring member penetrates the upper face of the flywheel.

12. The adjustable clutch or torque control device of claim 1, further comprising an adjustment mechanism slot or hole, wherein the adjustment mechanism penetrates the flywheel through the adjustment mechanism slot or hole and axially or radially extends into the flywheel and engages the at least one spring member to adjust the spring characteristics of the at least one spring member and thereby the engagement point of the shoe member.

13. An adjustable clutch or torque control device comprising:
a flywheel;
an at least one shoe or friction transfer device; and
at least one spring member, wherein a portion of the spring or an extension of the spring penetrates the plane of the flywheel where it intersects or is acted upon by a device which effects the tension of the at least one spring member and is adjustable by a user without disassembly of the adjustable clutch or torque control device.

14. The adjustable clutch or torque control device of claim 13, wherein the at least one shoe or friction transfer device comprises three shoes or friction transfer devices and the at least one spring member further comprises three spring members.

15. The adjustable clutch or torque control device of claim 13, wherein the at least one flywheel engages a crankshaft in a remotely controlled vehicle and transfers power from an internal combustion engine.

16. The adjustable clutch or torque control device of claim 13, wherein the at least one spring

17. The adjustable clutch or torque control device of claim 13, wherein the at least one shoe is guided by a pin pivot point.

18. The adjustable clutch or torque control device of claim 13, wherein the at least one shoe is guided by a set of grooves in the flywheel.

19. The adjustable clutch or torque control device of claim 13, wherein the flywheel has an upper face and the at least one spring member or a carrier for the at least one spring member penetrates the upper face of the flywheel.

20. The adjustable clutch or torque control device of claim 13, further comprising an adjustment mechanism slot or hole, wherein the adjustment mechanism penetrates the flywheel through the adjustment mechanism slot or hole and axially or radially extends into the flywheel and engages the at least one spring member to adjust the spring characteristics of the at least one spring member and thereby the engagement point of the shoe member.

21. An adjustable clutch or torque control device comprising:
a flywheel;
at least one shoe or friction transfer device; and
at least one spring member, wherein a portion of a spring tension control mechanism penetrates out from the plane of the flywheel and intersects with the at least one spring member or any extension of the at least one spring member and is acted upon to effect the tension of the at least one spring member without disassembly of the flywheel, the at least one shoe or friction transfer device, or the at least one spring member.

22. The adjustable clutch or torque control device of claim 21, wherein the at least one flywheel engages a crankshaft in a remotely controlled vehicle.

23. The adjustable clutch or torque control device of claim 21, wherein the at least one spring member is completely recessed within the flywheel.

24. The adjustable clutch or torque control device of claim 21, wherein the at least one shoe is guided by a pin pivot point or the at least one shoe is guided by a set of grooves in the flywheel.

25. The adjustable clutch or torque control device of claim 21, wherein the flywheel has an upper face and the at least one spring member or a carrier for the at least one spring member penetrates the upper face of the flywheel.

26. The adjustable clutch or torque control device of claim 21, further comprising an adjustment mechanism slot or hole, wherein the adjustment mechanism penetrates the flywheel through the adjustment mechanism slot or hole and axially or radially extends into the flywheel and engages the at least one spring member to adjust the spring characteristics of the at least one spring member and thereby the engagement point of the at least one shoe member.
